(19) United States
(12) Patent Application Publication
(10) Pub. No.: US 2007/0299369 A1
(43) Pub. Date: Dec. 27, 2007

(54) Ultrasound wound care device and method

(76) Inventor: Eilaz Babaev, Minnetonka, MN (US)

Correspondence Address: Bacoustics, LLC, 5929 BAKER ROAD, SUITE 470, MINNETONKA, MN, 55345, US

(21) Appl. No.: 11/474,695

(22) Filed: Jun. 26, 2006

(51) Int. Cl. A61H 1/00

(52) U.S. Cl. 601/2; 604/289; 604/22

(57) ABSTRACT

The present invention relates to an ultrasound device and method for treating wounds. The ultrasound wound care device comprises a generator, an ultrasound transducer, an ultrasound horn, and a cavitation chamber. The device may further comprise a fluid, non-atomized, coupling medium. Ultrasound entering the cavitation chamber induces cavitations within the coupling medium, providing therapeutic benefits to the wound being treated. The ultrasound entering the cavitation chamber is also transmitted through the coupling medium to the wound, providing direct therapeutic benefits to the wound.

### BACKGROUND OF THE INVENTION

1. Field of the Invention

The present invention relates to a wound care device and method for providing therapeutic benefits directly and indirectly from the transmission of ultrasound through a coupling medium.

2. Description of the Related Art

Wounds encountered in clinical practice can be slow to heal and difficult to manage. Such wounds are often seen in diabetics, the elderly, individuals with comprised immune systems, and other at risk patient populations. The pain produced by such wounds disables the patient, thereby reducing the patient's quality of life. An unhealed wound's susceptibility to infection increases a patient's morbidity and mortality. Placing the patient in an environment abundant in drug resistant infectious agents, such as hospital or institutional settings, further increases the patient's morbidity and mortality. Treating such wounds, especially after a serious infection has set in, burdens healthcare providers by increasing the time and resources that must be devoted to a single patient.

Maintaining a wound in a moist state free of infections with a good blood supply and the correct balance of anti-inflammatory drugs is considered to be the ideal treatment to promote healing. (Jones et al. 2005) Attempting to create the ideal treatment, medical device manufactures and inventors have created a variety of devices utilizing topical negative pressure therapy or ultrasound.

Topical negative pressure therapy applies a controlled negative pressure to the surface of the wound. Generally, the negative pressure is created by a vacuum pump or similar mechanism. Represented devices are encompassed in (U.S. Pat. No. 7,004,915 to Boynton et al.; U.S. Pat. No. 6,994,702 to Johnson; U.S. Pat. No. 6,695,823 to Lina et al.; and U.S. Pat. No. 6,135,116 to Vogel et al.). Topical negative pressure therapy devices have been shown to increase blood flow to the wound and the rate of granulation, or tissue growth, while decreasing the level of bacteria and inflammatory agents present. Topical negative pressure therapy, however, have several limitations. Ineffective in treating sloughy or grossly infected wounds, topical negative pressure therapy devices are only capable of promoting healing in clean and debrided wound beds. (Jones et al. 2005) Furthermore, negative pressure therapy is contraindicated over necrotic tissue (Jones et al. 2005), the presence of which can hinder or prevent healing. High rental costs and expensive silver dressings further limit the applicability of topical negative pressure devices in wound care. This is especially true in light of the fact that 4 to 6 weeks of continuous therapy is required, during which time the machine cannot be used on more than one patient.

Re-injuring the wound when the dressings are changed further limits topical negative pressure therapy devices. The dressings employed by such devices are porous by necessity. As the wound heals, new tissue grows into the porous openings of the dressing. When the dressing is removed, healed tissue is removed with it.

Delivering ultrasonic energy through atomized liquid coupling mediums, ultrasonic wound care devices treat wounds by increasing blood flow to the wound. Represented devices are encompassed in (U.S. Pat. No. 7,025,735 to Soring et al.; U.S. Pat. No. 6,964,647 to Babaev; U.S. Pat. No. 6,960,173 to Babaev; U.S. Pat. No. 6,916,296 to Soring; U.S. Pat. No. 6,761,729 to Babaev; U.S. Pat. No. 6,723,064 to Babaev; U.S. Pat. No. 6,663,554 to Babaev; U.S. Pat. No. 6,623,444 to Babaev; U.S. Pat. No. 6,601,581 to Babaev; U.S. Pat. No. 6,569,099 to Babaev; U.S. Pat. No. 6,533,803 to Babaev; and U.S. Pat. No. 6,478,754 to Babaev). Lacking relatively immediate contact with the target wound, these devices provide an inefficient transfer of ultrasound energy to the wound. Consequently, the ability of these devices to clean the wound, remove necrotic tissue, or destroy infectious agents is limited.

Incapable of obtaining ideal wound treatment from the current negative pressure therapy or ultrasound devices, a need exists for an effective and low cost wound care device capable of moistening and disinfecting a wound, removing necrotic tissue from the wound, increasing blood flow to the wound, and delivering anti-inflammatory agents to the wound.

### SUMMARY OF THE INVENTION

The present invention relates to a wound care device and method for providing therapeutic benefits directly and indirectly from the transmission of ultrasound through a coupling medium. The ultrasound wound care device comprises a generator, an ultrasound transducer, an ultrasound horn, and a cavitation chamber. The device may further comprise a fluid, non-atomized, coupling medium. Ultrasound entering the cavitation chamber induces cavitations within the coupling medium, providing therapeutic benefits to the wound being treated. The ultrasound entering the cavitation chamber is also transmitted through the coupling medium to the wound, providing direct therapeutic benefits to the wound.

Ultrasonically inducing negative and positive pressure over the surface of a wound, the present invention treats wounds and assists wound healing. The cavitation chamber, located at the distal end of the ultrasound horn, contains an inner cavity, open at its base, capable of holding a fluid coupling medium. Ultrasonic energy emitted from the present invention induces cavitations within the coupling medium held in the cavitation chamber, leading to the formation of gas bubbles within the coupling medium. This phenomenon is similar to water boiling, but is not the result of heating the coupling medium. As gas bubbles form and dissipate against the surface of the wound micro domains of topical positive and negative pressure are created over the wound's surface. The alternating pressure removes necrotic tissue and other contaminates from the wound.

The coupling medium within the cavitation chamber is a fluid medium that carries the ultrasonic waves emitted from the present invention to the wound being treated. The coupling medium may be a liquid, gel, or similar fluid medium. Dissolving or suspending drugs within the coupling medium may be done to assist drug delivery during wound treatment. Liberating the dissolved or suspended drug from the coupling medium while inducing macro cavitations on the surface of the wound and micro cavitations along with micro streaming within the wound bed, the ultrasound waves transport the drug into and across the wound bed. The coupling medium is also capable of moistening the wound.

Within the wound, ultrasound waves induce micro cavitation and microstreaming. Killing bacteria and other infectious agents, the induced micro cavitation disinfects the wound while cavitations within the coupling medium remove infectious agents from the wound. Inducing microstreaming within the wound bed, the delivered ultrasound waves increase blood flow to the wound bed, thereby allowing for the increased delivery of nutrients to the wound and the removal of inflammatory agents from the wound. The fluctuating topical pressure also helps to promote blood and nutrient flow to the wound bed and the removal of inflammatory agents. Producing overlapping healing benefits, the fluctuating topical pressure and delivered ultrasound waves exaggerate the actions of either when used alone, thereby creating a synergistic healing action.

The healing action of the present invention may be furthered enhanced by providing a positive or negative pressure to the inner cavity of the cavitation chamber by feeding the coupling medium into the inner cavity with a pump or by extracting the coupling medium with a vacuum. Driving the coupling medium into the inner cavity of the cavitation chamber with a pump places a general positive pressure against the surface of the wound. Similarly, extracting the coupling medium from the inner cavity of the cavitation chamber with a vacuum places a general negative pressure against the surface of the wound. Utilizing both a pump and vacuum the user of the device may control the general pressure within the inner cavity of the cavitation chamber and alternate the pressure from positive to negative or negative to positive during treatment. Simultaneously delivering ultrasound waves to the wound, the present invention creates a synergistic combination of ultrasound and topical pressure wound therapy.

Flowing coupling medium through the inner cavity of the cavitation chamber enables the user to flush out debris, necrotic tissue, bacteria, and other contaminants removed from the wound during treatment.

Treating a wound with the present invention does not require continued use of the device until the wound is healed. Rather, the device is used intermittently to treat a patient's wound. After a patient has received a treatment session, the device can be cleaned and sterilized and then used to treat other patients.

One aspect of the present invention may be to treat wounds and assist wound healing.

Another aspect of the present invention may be to remove necrotic tissue, infectious agents, and other contaminants from the wound.

Another aspect of the present invention may be to deliver drugs to the wound.

Another aspect of the present invention may be to moisten the wound.

Another aspect of the present invention may be to disinfect the wound by killing bacteria and other infectious agents.

Another aspect of the present invention may be to increase the blood flow to the wound bed.

Another aspect of the present invention may be to increase the delivery of nutrients to the wound.

Another aspect of the present invention may be to remove inflammatory agents from the wound.

Another aspect of the present invention may be to create microdomains of fluctuating pressure over the surface of the wound being treated.

Another aspect of the present invention may be to provide topical pressure therapy.

Another aspect of the present invention may be to alternate pressure from positive to negative or negative to positive during treatment.

Another aspect of the present invention may be to create a synergistic relationship between ultrasound therapy and topical pressure therapy.

Another aspect of the present invention may be to flush out debris, necrotic tissue, bacterial, and other contaminants from the wound.

Another aspect of the present invention may be to allow for the simultaneous treatment of multiple patients with a single device.

These and other aspects of the invention will become more apparent from the written descriptions and figures below.

### BRIEF DESCRIPTION OF THE DRAWINGS

FIG. 1 depicts a system view of the present invention.

FIG. 2 depicts a cross-sectional view of an alternative configuration of the present invention further comprising a feed channel.

FIG. 3 depicts a cross-sectional view of an alternative configuration of the present invention further comprising a feed channel and an extraction channel.

FIG. 4 depicts a cross-sectional view of an alternative configuration of the present invention further comprising an ultrasound tip and feed channel.

FIG. 5 depicts a cross-sectional view of an alternative configuration of the present invention further comprising an ultrasound tip, a feed channel, and an extraction channel.

FIG. 6 depicts a system view and a cross-sectional view of a cavitation chamber for use with the present invention.

FIG. 7 depicts a cross-sectional view of an alternative configuration of the cavitation chamber comprising an accordion like base.

FIG. 8 depicts a system view and a cross-sectional view of alternative mechanical means of attaching the cavitation chamber to the horn and/or tip.

FIG. 9 depicts an ultrasound tip for use with the present invention.

FIG. 10 depicts cross-sectional views of various ultrasound tip configurations that may be used with the present invention.

### DETAILED DESCRIPTION OF THE INVENTION

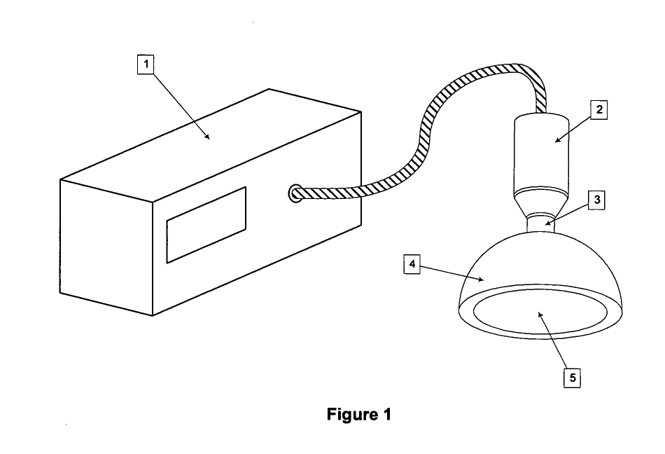

Depicted in FIG. 1 is the wound care device of the present invention. The device comprises a generator 1 connected to an ultrasound transducer 2, an ultrasound horn 3 located at the distal end of the transducer 2, and a cavitation chamber 4 at the distal end of horn 3. The horn 3 is located at the outer apex of the cavitation chamber 4. The outer apex of the cavitation chamber 4 refers to the region at or near the chamber's top. An ultrasound horn is located at the apex of the chamber if it transmits longitudinal ultrasound waves into the wound. The cavitation chamber 4 comprises an inner cavity 5 open at its base, capable of holding a fluid, non-atomized, coupling medium, not shown. Eliminating splash back, the cavitation chamber protects the user of the device and the surrounding environment from contamination while the patient is being treated. The coupling medium held within the cavitation chamber may be a liquid, gel, or similar fluid medium. Although a coupling medium that fails to atomize when exposed to ultrasound waves is preferred, an atomized coupling medium may also be employed.

The coupling medium may be a saline solution. The coupling medium may also be a solution containing drugs and/or other healing agents, such as, but not limited to, anticoagulants, anti-inflammatory agents, anti-viral agents, antibiotics, or vitamins. The drugs or other healing agents may be suspended and/or dissolved within the coupling medium.

In keeping with FIG. 1, the cavitation chamber 4 may be integral with the horn 3 as to form a single part. Alternatively, the cavitation chamber 4 may be a separate piece attached to the horn 3 by mechanical or other means. The means of attaching the cavitation chamber 4 to horn 3 may be such as to allow the cavitation chamber 4 to be removed and replaced by the user. A removable cavitation chamber enables the user to adjust the size and/or configuration of the treatment area as to conform to the wound being treated.

In keeping with FIG. 1, the horn 3 may be integral with the transducer 2 as to form a single part. Alternatively, the horn 3 may be separate piece, either alone or in combination with cavitation chamber 4, attached to the transducer 2 by mechanical or other means. The means of attaching the horn 3 to the transducer 2 may be such as to allow the horn to be removed and replaced by the user. A removable horn enables the user to adjust the parameters of the emitted ultrasound waves. In so doing, the user may configure the device to emit ultrasound waves that induce a desired type of cavitation within and/or better match the coupling medium chosen. A removable horn also enables the user to configure the device to emit ultrasound waves which are best suited to type of wound being treated.

The ultrasound waves employed may vary with respect to frequency; approximately 15 kHz to 20 MHz. The preferred low-frequency range is approximately 20 kHz-100 kHz. The more preferred low-frequency range is approximately 25 kHz-50 kHz. The recommend low-frequency is approximately 30 kHz. The preferred high-frequency ultrasound range is approximately 0.7 MHz-3 MHz. The more preferred high-frequency range is approximately 0.7 MHz-3 MHz. The recommend high-frequency is approximately 0.7 MHz. The ultrasound waves employed may also vary with respect to amplitude; approximately 1 micron and above. The preferred low-frequency amplitude is approximately 30 microns-100 microns. The recommended low-frequency amplitude is approximately 100 microns. The high-frequency amplitude can be 1 micron and above. The preferred high-frequency amplitude is approximately 5 microns. The recommended high-frequency amplitude is approximately 10 microns. Employing low frequency ultrasound waves is the preferred method of treatment.

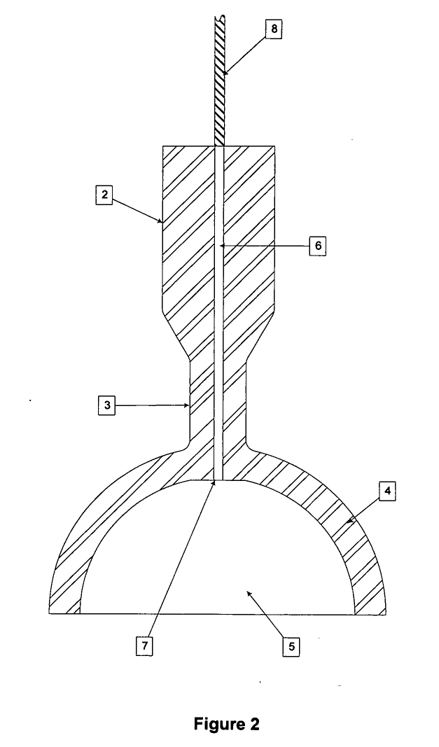

FIG. 2 depicts a cross-sectional view of an alternative configuration of the present invention comprising a feed channel 6 running through the transducer 2 and horn 3 before ending in a feed orifice 7 located within the inner cavity 5 of the cavitation chamber 4. Connected to the proximal end of the feed channel 6, tubing 8 carries coupling medium, not shown, to the feed channel 6. The coupling medium then flows through the feed channel 6 and into the inner cavity 5 of the cavitation chamber 4. Tubing 8 may be attached to a pump, not shown, as to force coupling medium through the feed channel 6 and into the inner cavity 5 of the cavitation chamber 4. Forcing the coupling medium into the inner cavity 5 of the cavitation chamber 4, the pumping unit creates a general positive pressure against the surface of the treated wound.

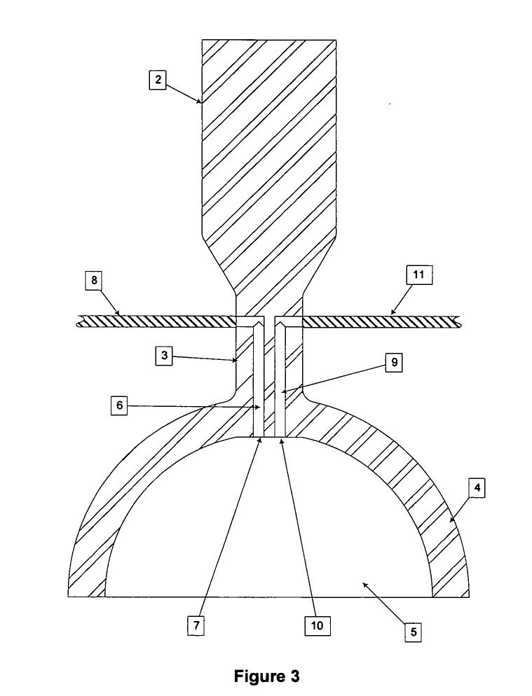

FIG. 3 depicts a cross-sectional view of an alternative configuration of the present invention comprising a feed channel 6 running through the horn 3 before ending in a feed orifice 7 located within the inner cavity 5 of the cavitation chamber 4 and an extraction channel 9 beginning at an extraction orifice 10 located within the inner cavity 5 of the cavitation chamber 4 and running through the horn 3. Connected to the proximal end of the feed channel 6, tubing 8 carries coupling medium to the feed channel 6. The coupling medium may be gravity fed into the feed channel 6 by means of an IV bag, or similar reservoir, located above the device. The coupling medium then flows through the feed channel 6 and into the inner cavity 5 of the cavitation chamber 4, providing delivery of fresh coupling medium and/or drugs to the wound bed. Creating a vortex within the inner cavity 5 of the cavitation chamber 4, the emitted ultrasound waves drive the coupling medium up the extraction channel 9. Tubing 11 attached to the extraction channel 9 carries the extracted coupling medium away from the present invention.

In keeping with FIG. 3, the tubing 8 may be attached to a pump as to force coupling medium through the feed channel 6 and into the inner cavity 5 of the cavitation chamber 4. To create a differential with respect to the flow of coupling medium in and out of the inner cavity 5 of the cavitation chamber 4, the extraction orifice 10 and/or extraction channel 9 may have a smaller internal diameter at one or more points than the smallest internal diameter within the feed channel 6 and feed orifice 7. The resulting differential in flow of the coupling medium in and out of the inner cavity 5 of the cavitation chamber 4 maintains a general positive pressure against the surface of the wound being treated, while permitting the coupling medium to flow out of the inner cavity 5 of the cavitation chamber 4 by means of the extraction channel 9. Exiting from the inner cavity 5 of the cavitation chamber 4, the coupling medium carries away from the wound removed necrotic tissue, infectious agents, and/or other contaminants.

Alternatively, the tubing 11, as depicted in FIG. 3, may be attached to a vacuum as to pull coupling medium out of the inner cavity 5 of the cavitation chamber 4 and up the extraction channel 9. Pulling coupling medium from the inner cavity 5 of the cavitation chamber 4, the vacuum unit draws coupling medium from the feed channel 6 into the inner cavity 5 of the cavitation chamber 4. To create a differential with respect to the flow of coupling medium in and out of the inner cavity 5 of the cavitation chamber 4, the feed channel 6 and/or feed orifice 7 may have a smaller internal diameter at one or more points than the smallest internal diameter of the extraction channel 9 and extraction orifice 10. The resulting differential in flow of the coupling medium in and out of the inner cavity 5 of the cavitation chamber 4 maintains a general negative pressure against the wound being treated, while permitting fresh coupling medium to flow into the inner cavity 5 of the cavitation chamber 4 through the feed orifice 7.

In yet another alternative configuration, the present invention, as depicted in FIG. 3, may contain a vacuum attached to tubing 11 and a pump attached to the tubing 8. The vacuum unit and the pump may be used in concert to create a flow differential of the coupling medium into and out of the inner cavity 5 of the cavitation chamber 4. Furthermore, the concerted use of a vacuum and pump allows the user to regulate and adjust the pressure applied to the surface of the wound being treated. The concerted use of a vacuum and pump also enables the user to alternate between applying general negative and positive pressure against the surface of the wound.

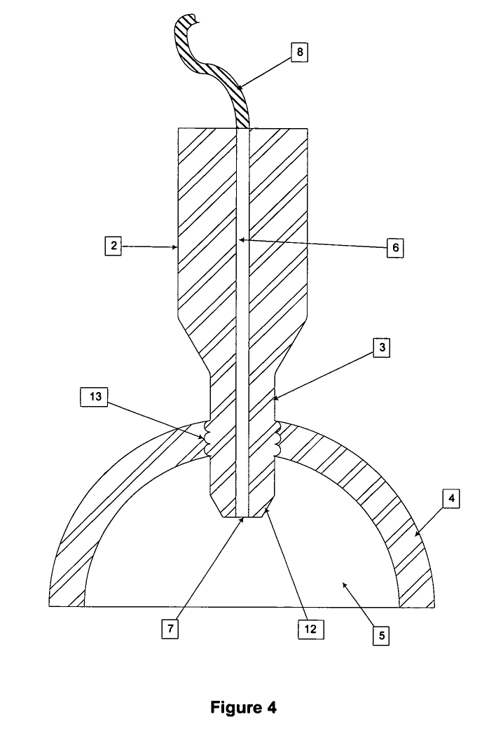

FIG. 4 depicts a cross-sectional view of an alternative configuration of the present invention comprising a ultrasound transducer 2, a horn 3 located at the distal end of the transducer 2, an ultrasound tip 12 at the distal end of the horn 3, and a cavitation chamber 4 located at or near the distal end of horn 3. The cavitation chamber 4 comprises an inner cavity 5 open at its base, capable of holding a fluid, non-atomized, coupling medium not shown. The cavitation chamber 4 may, but need not, envelope tip 12. The tip may be located within or outside of the cavitation chamber. The cavitation chamber 4 may be integral with the horn 3 and/or tip 12. Alternatively, the cavitation chamber 4 may be a separate piece attached to the horn 3 and/or tip 12 by mechanical means 13. Other means of attaching the cavitation chamber such as, but not limited to, chemical or magnetic, may be equally effective. The means of attaching the cavitation chamber 4 to horn 3 or tip 12 may be such as to allow the cavitation chamber 4 to be removed and replaced by the user. A removable cavitation chamber enables the user to adjust the size and/or configuration of the treatment area as to conform to the wound being treated. The tip 12 may be integral with the horn 3, outer apex of the cavitation chamber 4, and/or inner apex of cavitation chamber 12. Alternatively, the tip 12 may be a separate piece attached to the horn 3, outer apex of the cavitation chamber 4, the inner apex of the cavitation chamber 4, or any combination thereof. The means of attaching the tip 12 to the horn 3, to the outer apex of the cavitation chamber 4, or to the inner apex of the cavitation chamber 4 may be such as to allow the tip 12 to be removed and replaced by the user. A removable tip enables the user to adjust delivery of ultrasound waves as to conform to the wound being treated and coupling medium being used. The inner apex of the cavitation chamber refers to the region at or near the top of inner cavity 5. An ultrasound tip is located at the apex of the inner cavity if it transmits longitudinal ultrasound waves into the wound.

In keeping with FIG. 4, the configuration may further comprise a feed channel 6 running through the transducer 2 and horn 3 before ending in a feed orifice 7 located within the tip 12. Connected to the proximal end of the feed channel 6, tubing 8 carries coupling medium to the feed channel 6. The coupling medium then flows through the feed channel 6 and into the inner cavity 5 of the cavitation chamber 4. The tubing 8 may be attached to a pump as to force coupling medium through the feed channel 6 and into the inner cavity of 5 the cavitation chamber 4.

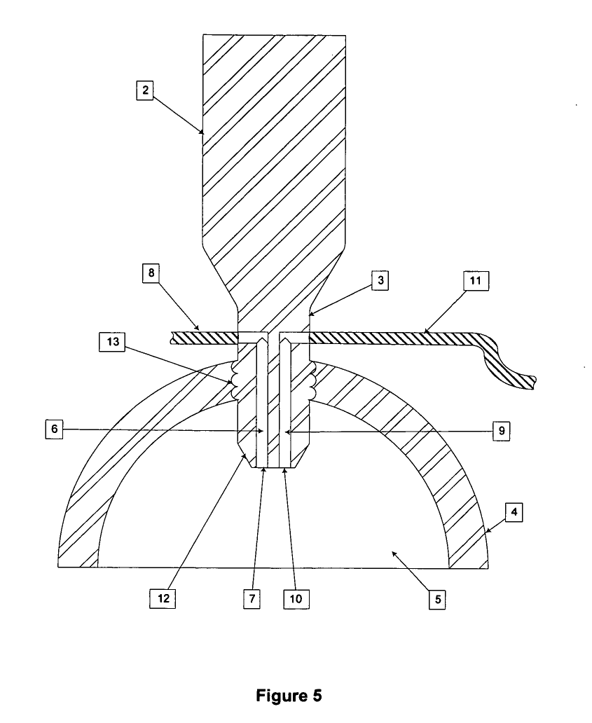

FIG. 5 depicts a cross-sectional view of an alternative configuration of the present invention comprising a feed channel 6 running through a portion of the device before ending in a feed orifice 7 located within the tip 12 and an extraction channel 9 beginning at an extraction orifice 10 located within the tip 12 and running through a portion of the device. Connected to the proximal end of the feed channel 6, tubing 8 carries coupling medium to the feed channel 6. The coupling medium then flows through the feed channel 6 and into the inner cavity 5 of the cavitation chamber 4. Creating a vortex within the inner cavity 5 of the cavitation chamber 4, the emitted ultrasound waves drive the coupling medium through the extraction orifice 10 and up the extraction channel 9. Tubing 11 attached to the extraction channel 9 carries the extracted coupling medium away from the device.

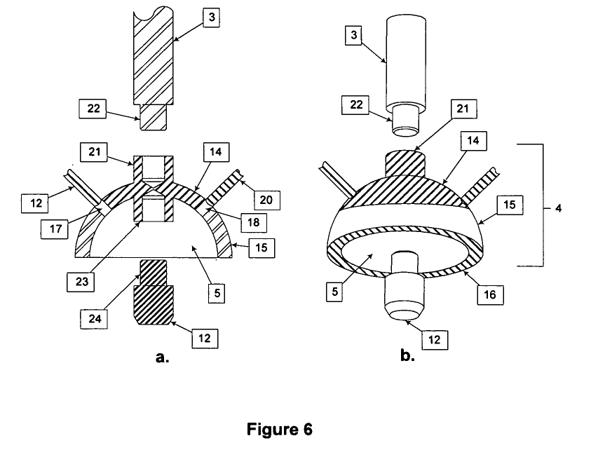

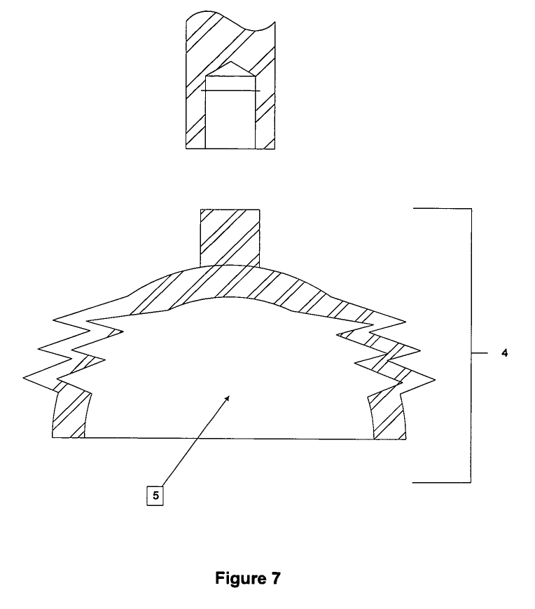

The cavitation chamber 4, depicted in detail in FIG. 6, comprises an inner cavity 5 open at its base. The cavitation chamber 4 may be constructed entirely from an autoclavable metallic and/or plastic substance as to permit sterilization after use. The cavitation chamber 4 may also be constructed entirely from a supple material, such as, but not limited to, a polymer or plastic. Alternatively, the cavitation chamber 4 may comprise a metallic apex 14 and a supple base 15. The supple base 15 may be constructed from a variety of materials such as, but not limited, to plastics or polymers. The material used to construct the supple base 15 may be thin film or sheet. Alternatively, the material used to construct the supple base 15 may be of sufficient rigidity to permit the chamber to retain geometric shape. Constructing the cavitation chamber 4 in whole or in part of a supple material allows the cavitation chamber 4 to conform to the contours of the patient's body when the wound treatment device of the present invention is pressed against the patient. Conforming to the patient's body, the cavitation chamber 4 is capable of forming a better seal as to retain coupling medium during treatment. Adding a liquid sealant 16 to the base of the cavitation chamber 4 further enhances the seal between base of the cavitation chamber and the patient's skin. The liquid sealant 16 may comprise, but is not limited to, silicon gel, medical gel, medical adhesive, or water. Furthermore, constructing the cavitation chamber 4 in whole or in part of a supple material allows the user to create an alternating general positive and general negative pressure against the wound by pushing down and lifting up on the device; similar in motion and effect to a plumber using a plunger to repair a clogged toilet. As to facilitate plunging the device, the base of cavitation chamber 4 may have an accordion like configuration, an example of which is depicted in FIG. 7.

Returning to FIG. 6, feed port 17 and extraction port 18 within the sides of the cavitation chamber 4 permit coupling medium to be fed into and extracted from the inner cavity 5. Tubing 19 attached to feed port 17 carries the coupling medium to the cavitation chamber 4. Tubing 20 attached to the extraction port 18 carries the extracted coupling medium away from the cavitation chamber 4. The tubing 19 may be attached to a pump as to force coupling medium through the feed port 17 and into the inner cavity 5. Forcing the coupling medium into the inner cavity 5, the pump creates a general positive pressure against the surface of the wound. To create a differential with respect to the flow of coupling medium in and out of the inner cavity 5, the extraction port 18 may have a smaller internal diameter at one or more points than the smallest internal diameter of feed port 17. The resulting differential in flow of the coupling medium in and out of the inner cavity 5 maintains a general positive pressure against the surface of the wound being treated while permitting coupling medium to flow out of the extraction port 18. Exiting from the cavitation chamber, the coupling medium carries away from the wound removed necrotic tissue, infectious agents, and/or other contaminants.

In keeping with FIG. 6, the tubing 20 may be attached to a vacuum as to pull coupling medium out of the inner cavity 5. Extracting the coupling medium from the inner cavity 5, the vacuum creates a general negative pressure against the surface of the treated wound. To create a differential with respect to the flow of coupling medium in and out of the inner cavity 5, the feed port 17 may have a smaller internal diameter at one or more points than the smallest internal diameter of the extraction port 18. The resulting differential in flow of the coupling medium in and out of the inner cavity 5 maintains a general negative pressure against the surface of the wound being treated while permitting fresh coupling medium to flow into the inner cavity 5 through the feed port 17.

In yet another alternative configuration, the cavitation chamber, as depicted in FIG. 6, may contain a vacuum unit attached to tubing 20 and a pump attached to tubing 19. The vacuum unit and the pump may be used in concert to create a flow differential of the coupling medium into and out the inner cavity 5. Furthermore, the concerted use of the vacuum and the pump allows the user to regulate and adjust the general pressure applied to the surface of the wound being treated. The concerted use of the vacuum and pump also enables the user to alternate between applying general negative and positive pressure against the surface of the wound.

In keeping with FIG. 6, mechanical means of connecting the cavitation chamber 4 to the horn 3 and/or tip 12, such that the cavitation chamber 4 may be removed from horn 3 and/or tip 12, may comprise a receptacle 21, on the outer apex of the cavitation chamber 4, that receives a protrusion 22 located at the distal end of the horn 3. At its inner apex, the cavitation chamber 4 may have a receptacle 23 that receives a protrusion 24 located at the proximal end of the tip 12. The protrusions 22 and 24 and receptacles 21 and 23 may be threaded. The outer apex of the cavitation chamber is the region opposite the apex of the inner cavity.

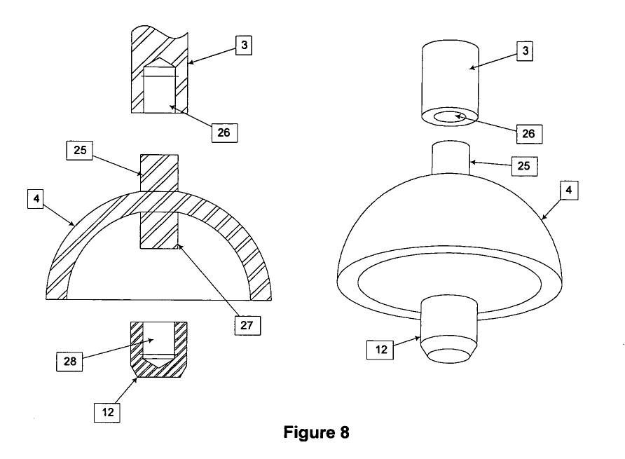

FIG. 8 depicts alternative mechanical means of attaching the cavitation chamber 4 to the horn 3 and/or tip 12. The cavitation chamber 4, at its outer apex, may have a protrusion 25 that fits a receptacle 26 located at the distal end of the horn 3. At its inner apex, the cavitation chamber 4 may have a metallic protrusion 27 that fits a receptacle 28 located at the proximal end of the tip 12. The protrusions 25 and 27 and receptacles 26 and 28 may be threaded. The cavitation chamber may comprise any combination of inner-outer-apex-protrusions-receptacles. Other mechanical means may be equally as effective in allowing the cavitation chamber to be separated from the tip and/or horn. Furthermore, means of attaching the tip to the inner apex of the cavitation chamber or horn other than mechanical, such as, but not limited to, chemical or magnetic, may be equally effective in securing the tip during treatment.

The general three-dimensional geometry of the cavitation chamber may be parabolic, as depicted in FIGS. 6 and 8, pyramidal, rectangular, elliptical, or polygonal. Likewise, the geometry of the cavitation chamber's base may be circular, as depicted in FIGS. 6 and 8, elliptical, rectangular, triangular, or polygonal. The enumerated geometries are merely exemplary and are not meant to be an exclusive or exhaustive listing of possible configurations.

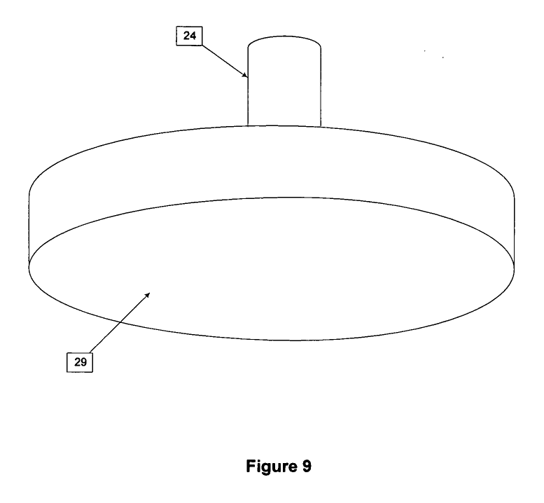

FIG. 9 depicts an ultrasound tip for use with the present invention comprising a radiation 29 surface at its distal end and means of attachment 24 at its proximal end. The means of attachment 24 may be, but are not limited to, mechanical, chemical, or magnetic, and the means of attachment 24 serve to secure the device to the inner apex of a cavitation chamber and/or the distal end of an ultrasound horn during treatment. The radiation surface 29, during treatment, emits ultrasound waves that induce cavitations within a coupling medium held with a cavitation chamber.

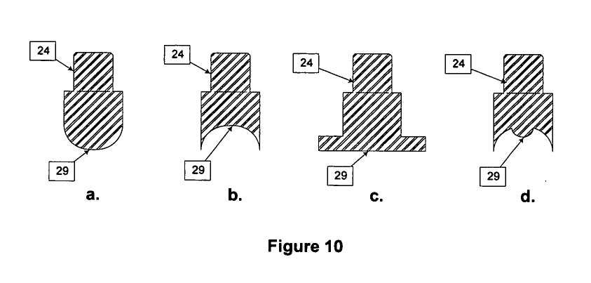

FIG. 10 depicts cross-sectional views of various ultrasound tip configurations that may be used with the present invention. The ultrasound tip comprises, at its distal end, a radiation surface 29 from which ultrasound waves are emitted. The radiation surface 29 may comprise a convex or concave geometry, as depicted in FIGS. 10.a and 10.b respectively. Alternatively, as depicted in FIG. 10.c, the radiation surface 28 may comprise a planar geometry. The radiation surface 29, as depicted in FIG. 10.d, may comprise an inner convex geometry surrounded by an outer concave geometry. Other geometries of the radiation surface 29 may also be effective and the exemplar geometries mentioned are not intended to be an exclusive or exhaustive list. As with the inner profiles depicted in FIG. 10, the outer peripheral boundary of the ultrasound tips radiation surface may take on a variety of geometries, such as, but not limited to, circular, elliptical, rectangular, triangular, or polygonal.

Although specific embodiments and methods of use have been illustrated and described herein, it will be appreciated by those of ordinary skill in the art that any arrangement that is calculated to achieve the same purpose may be substituted for the specific embodiments and methods shown. It is to be understood that the above description is intended to be illustrative and not restrictive. Combinations of the above embodiments and other embodiments as well as combinations of the above methods of use and other methods of use will be apparent to those having skill in the art upon review of the present disclosure. The scope of the present invention should be determined with reference to the appended claims, along with the full scope of equivalents to which such claims are entitled.

I claim:

1. A wound treatment device comprising:
a. a generator;
b. an ultrasound transducer connected to said generator;
c. a horn at the distal end of said transducer; and
d. a cavitation chamber at the distal end of said horn.

2. The device of claim 1, further comprising a fluid, non-atomized, coupling medium.

3. The device of claim 1, further comprising a means of introducing a coupling medium into the cavitation chamber.

4. The device of claim 1, further comprising a means of extracting a coupling medium from said cavitation chamber.

5. The device of claim 1, further comprising a pump in communication with said cavitation chamber.

6. The device of claim 1, further comprising a vacuum in communication with said cavitation chamber.

7. The device of claim 1, wherein said cavitation chamber is connected to said horn by mechanical means.

8. The device of claim 1, wherein said horn is connected to said transducer by mechanical means.

9. The device of claim 1, further comprising a feed channel running through at least a portion of the device and terminating in a feed orifice located within said cavitation chamber.

10. The device of claim 9, wherein the proximal end of said feed channel extends through said transducer.

11. The device of claim 9, wherein the proximal end of said feed channel is located within the side of the horn or transducer.

12. The device of claim 9, further comprising a means of introducing a coupling medium into said feed channel.

13. The device of claim 9, further comprising tubing connected to the proximal end of said feed channel.

14. The device of claim 13, further comprising a pump attached to said tubing, wherein said pump forces a coupling medium into the cavitation chamber.

15. The device of claim 13, further comprising an extraction channel running through at least a portion of the device and originating in an extraction orifice within said cavitation chamber, wherein said extraction orifice and/or said extraction channel has a smaller internal diameter at one or more points than the smallest internal diameter of the feed channel and feed orifice.

16. The device of claim 1, further comprising an extraction channel running through at least a portion of the device and originating in an extraction orifice within said cavitation chamber.

17. The device of claim 16, further comprising a means of extracting a coupling medium from said extraction chamber.

18. The device of claim 16, wherein the proximal end of said extraction channel extends through said transducer.

19. The device of claim 16, wherein the proximal end of said extraction channel is located with the side of the horn or transducers.

20. The device of claim 19, further comprising tubing connected to the proximal end of said extraction channel.

21. The device of claim 20, further comprising a vacuum attached to said extraction tubing where said vacuum extracts a coupling a medium from the cavitation chamber.

22. The device of claim 20, further comprising a feed channel running through at least a portion of the device and terminating in a feed orifice within the cavitation chamber, wherein said feed orifice and/or said feed channel has a smaller internal diameter at one or more points than the smallest internal diameter of the extraction channel and extraction orifice.

23. The device of claim 1, further comprising an ultrasound tip at the distal end of said horn.

24. The device of claim 23, wherein said cavitation chamber envelopes said tip.

25. The device of claim 23, wherein said tip is located at the outer apex of said cavitation chamber.

26. The device of claim 9, wherein said feed channel extends through an ultrasound tip at the distal end of the horn.

27. The device of claim 16, wherein said extraction channel extends through an ultrasound tip at the distal end of the horn.

28. The device of claim 1, wherein the ultrasound waves emitted into said cavitation chamber comprise a frequency in the approximate range of 15 kHz-20 MHz.

29. The device of claim 1, wherein the ultrasound waves emitted into said cavitation chamber comprise a preferred low-frequency in the approximate range of 20 kHz-100 kHz.

30. The device of claim 1, wherein the ultrasound waves emitted into said cavitation chamber comprise a more preferred low-frequency in the approximate range of 25 kHz-50 kHz.

31. The device of claim 1, wherein the ultrasound waves emitted into said cavitation chamber comprise a recommended low-frequency of approximately 30 kHz.

32. The device of claim 1, wherein the ultrasound waves emitted into said cavitation chamber comprise a preferred high-frequency in the approximate range of 0.7 MHz-3 MHz.

33. The device of claim 1, wherein the ultrasound waves emitted into said cavitation chamber comprise a more preferred high-frequency in the approximate range of 0.7 MHz-1 MHz.

34. The device of claim 1, wherein the ultrasound waves emitted into said cavitation chamber comprise a recommended high-frequency of approximately 0.7 MHz.

35. The device of claim 1, wherein the ultrasound waves emitted into said cavitation chamber comprise an amplitude of at least 1 micron.

36. The device of claim 1, wherein the ultrasound waves emitted into said cavitation chamber comprise a preferred low-frequency amplitude in the range of approximately 30-250 microns.

37. The device of claim 1, wherein the ultrasound waves emitted into said cavitation chamber comprise a recommended low-frequency amplitude of approximately 100 microns.

38. The device of claim 1, wherein the ultrasound waves emitted into said cavitation chamber comprise high-frequency amplitude of at least 1 micron.

39. The device of claim 1, wherein the ultrasound waves emitted into said cavitation chamber comprise a preferred high-frequency amplitude of at least 5 microns.

40. The device of claim 1, wherein the ultrasound waves emitted into said cavitation chamber comprise a recommended high-frequency amplitude of approximately 10 microns.

41. A cavitation chamber comprising an inner cavity, wherein said cavity opens at the chamber's base.

42. The chamber of claim 41, further comprising a metal apex

43. The chamber of claim 41, further comprising a supple base.

44. The chamber of claim 41, further comprising a feed port.

45. The chamber of claim 44, further comprising a means of introducing a coupling medium into the inner cavity, through said feed port.

46. The chamber of claim 44, further comprising tubing connected to said feed port.

47. The chamber of claim 46, further comprising a pump attached to said tubing, wherein said pump forces a coupling medium into the inner cavity.

48. The chamber of claim 44, further comprising an extraction port, wherein said extraction port has a smaller internal diameter at one or more points than the smallest internal diameter of the feed port.

49. The chamber of claim 41, further comprising an extraction port.

50. The chamber of claim 49, further comprising a means of extracting a coupling medium from the inner cavity, through said extraction port.

51. The chamber of claim 49, further comprising tubing connected to said extraction port.

52. The chamber of claim 51, further comprising a vacuum attached to said tubing, wherein said vacuum extracts a coupling medium from the inner cavity.

53. The chamber of claim 49, further comprising a feed port, wherein said feed port has a smaller internal diameter at one or more points than the smallest internal diameter of the extraction port.

54. The chamber of claim 41, further comprising an ultrasound tip located at the inner apex of said inner cavity.

55. The chamber of claim 41, further comprising an ultrasound tip located it outer apex.

56. The chamber of claim 41, further comprising a liquid sealant at its base.

57. The chamber of claim 41, further comprising mechanical means of attaching the chamber to an ultrasound horn and/or tip.

58. The chamber of claim 43, further comprising a supple base having an accordion like configuration.

59. An ultrasound tip comprising:
a. a radiation surface at its distal end; and
b. wherein said radiation surface emits ultrasound waves capable of inducing cavitations within a coupling medium held within a cavitation chamber.

60. The ultrasound tip of claim 59, further comprising means of attachment at its proximal end.

61. The ultrasound tip of claim 59, wherein said means of attachment attach the tip to the inner apex of a cavitation chamber.

62. The ultrasound tip of claim 59, wherein said means of attachment attach the tip to the distal end of an ultrasound horn.

63. The ultrasound tip of claim 59, further comprising means of attachment at its distal end,

64. The ultrasound tip of claim 59, wherein said means of attachment attach the tip to the outer apex of a cavitation chamber.

65. A method of treating wounds comprising the steps of:
a. placing a fluid coupling medium on the surface of the wound; and
b. inducing cavitations within said coupling medium with ultrasound waves.

66. The method of claim 65, further comprising the step of placing a cavitation chamber over the surface of the wound, wherein said cavitation chamber holds said coupling medium.

67. The method of claim 65, further comprising the step of creating a general positive pressure over the surface of the wound.

68. The method of claim 65, further comprising the step of creating a general negative pressure over the surface of the wound.

69. The method of claim 65, further comprising the step of creating an alternating general positive and general negative pressure over the surface of the wound.

70. The method of claim 65, further comprising the step of dissolving or suspending drugs in said coupling medium.

71. The method of claim 65, wherein the ultrasound waves inducing cavitations within said coupling medium comprise a frequency in the approximate range of 15 kHz-20 MHz.

72. The method of claim 65, wherein the ultrasound waves inducing cavitations within said coupling medium comprise a preferred low-frequency in the approximate range of 20 kHz-100 kHz.

73. The method of claim 65, wherein the ultrasound waves inducing cavitations within said coupling medium comprise a more preferred low-frequency in the approximate range of 25 kHz-50 kHz.

74. The method of claim 65, wherein the ultrasound waves inducing cavitations within said coupling medium comprise a recommended low-frequency of approximately 30 kHz.

75. The method of claim 65, wherein the ultrasound waves inducing cavitations within said coupling medium comprise a preferred high-frequency in the approximate range of 0.7 MHz-3 MHz.

76. The method of claim 65, wherein the ultrasound waves inducing cavitations within said coupling medium comprise a more preferred high-frequency in the approximate range of 0.7 MHz-1 MHz.

77. The method of claim 65, wherein the ultrasound waves inducing cavitations within said coupling medium comprise a recommended high-frequency of approximately 0.7 MHz.

78. The method of claim 65, wherein the ultrasound waves inducing cavitations within said coupling medium comprise an amplitude of at least 1 micron.

79. The method of claim 65, wherein the ultrasound waves inducing cavitations within said coupling medium comprise a preferred low-frequency amplitude in the range of approximately 30-250 microns.

80. The method of claim 65, wherein the ultrasound waves inducing cavitations within said coupling medium comprise a recommended low-frequency amplitude of approximately 100 microns.

81. The method of claim 65, wherein the ultrasound waves inducing cavitations within said coupling medium comprise high-frequency with an amplitude of at least 1 micron.

82. The method of claim 65, wherein the ultrasound waves inducing cavitations within said coupling medium comprise a preferred high-frequency amplitude of at least 5 microns.

83. The method of claim 65, wherein the ultrasound waves inducing cavitations within said coupling medium comprise a recommended high-frequency amplitude of approximately 10 microns.
